(19) United States
(12) Patent Application Publication
(10) Pub. No.: US 2014/0123274 A1
(43) Pub. Date: May 1, 2014

(54) Password Setting and Verification

(71) Applicant: INTERNATIONAL BUSINESS MACHINES CORPORATION, Armonk, NY (US)

(72) Inventors: Feng Chen, Shanghai (CN); Pan Liu, Shanghai (CN); Xiao Yu Wang, Shanghai (CN); Ziao Zhi Yan, Shanghai (CN)

(21) Appl. No.: 14/059,612

(22) Filed: Oct. 22, 2013

(30) Foreign Application Priority Data
Oct. 31, 2012 (CN) 201210428029.0

(51) Int. Cl. G06F 21/46; G06F 21/31

(52) U.S. Cl. CPC G06F 21/46; G06F 21/31
USPC 726/18; 726/19

(57) ABSTRACT

Methods and systems for setting and verifying a password in a password protected device. Setting a password includes receiving a configuration password entered via a keyboard, wherein the configuration password includes position information of at least one key on the keyboard, and symbol information of at least one key on the keyboard, and storing the configuration password. Verifying a password includes receiving an entered password on the keyboard, obtaining a stored configuration password, wherein the configuration password includes position information of at least one key on the keyboard and symbol information of at least one key on the keyboard, and verifying the entered password based on the configuration password. The keyboard may be a randomly arranged keyboard. Even if nearby persons can see the selection of symbols displayed on the keys for a password, they cannot determine the real content of the password, and thus cannot access the password-protected device.

### CROSS-REFERENCE TO RELATED APPLICATION

This application claims priority to Chinese patent application serial no. 201210428029.0, tiled Oct. 31, 2012, which is hereby incorporated by reference herein.

### TECHNICAL FIELD

The present disclosure relates to information security, and more specifically, to setting and verifying a password in a password protected device or device feature.

### BACKGROUND

More electronic devices are being designed to store larger amounts of information. Typically, passwords are configured for these devices, or features implemented on the devices, to prevent unauthorized access of information. Passwords may be entered via a hardware keyboard, e.g., for desktop computers, servers, ATM machines, etc., or may be entered via a software keyboard, such as on a touch screen of a device.

Since the layouts of most device keyboards are the same, it is easy for another person nearby to snoop (i.e., determine) the password by observing the user press the positions of keys on the keyboard. Therefore, a random keyboard layout has been developed in the prior art, in which the relationships between the positions of keys in a hardware or software keyboard and the symbols (e.g., alphanumeric and other characters) are not always the same, but dynamically defined by the system, for example by using a function with a random number as a preference. Thus, the layout of the keyboard (i.e., positions of the key symbols) is different each time the user is prompted for a password (for example, where positions of the number keys 0-9 located on the keyboard are different each time the user is prompted for a password), making it difficult for a nearby person to snoop the password when the user enters it for authentication (i.e., verification of the password).

However, as more people crowd into urban areas and thus more often end up in closer proximity to each other (e.g., when people queue in public places, or in public transportation), it becomes more inevitable that someone will be nearby a user of a device, making it quite easy for such persons to directly view the input of a password, sometimes even the symbols on the keys, which makes the random keyboard layout less effective. The prior art does not disclose a way to prevent people nearby from directly glimpsing entry of a password eve with random keyboard layouts. In such a scenario, people's requirements for privacy and confidentiality are easily compromised.

### BRIEF DESCRIPTION OF THE SEVERAL VIEWS OF THE DRAWINGS

FIG. 1 illustrates an exemplary computer system 100 that is applicable to implement embodiments of the present invention, including the systems illustrated in FIGS. 7-8;

FIG. 2 illustrates a flow diagram of a process for setting a password in accordance with embodiments of the present invention;

FIG. 3 illustrates a schematic representation of an example of a numeric keyboard with a position (“POS”) key;

FIG. 4 illustrates a schematic representation of an example of a randomly arranged numeric keyboard;

FIG. 5 illustrates a flow diagram of a process for verifying a password in accordance with embodiments of the present invention;

FIG. 6. illustrates a schematic representation of an example of a computer keyboard;

FIG. 7 illustrates a block diagram of a system for setting a password in accordance with embodiments of the present invention; and

FIG. 8 illustrates a block diagram of a system for verifying a password according to embodiments of the present invention.

### DETAILED DESCRIPTION

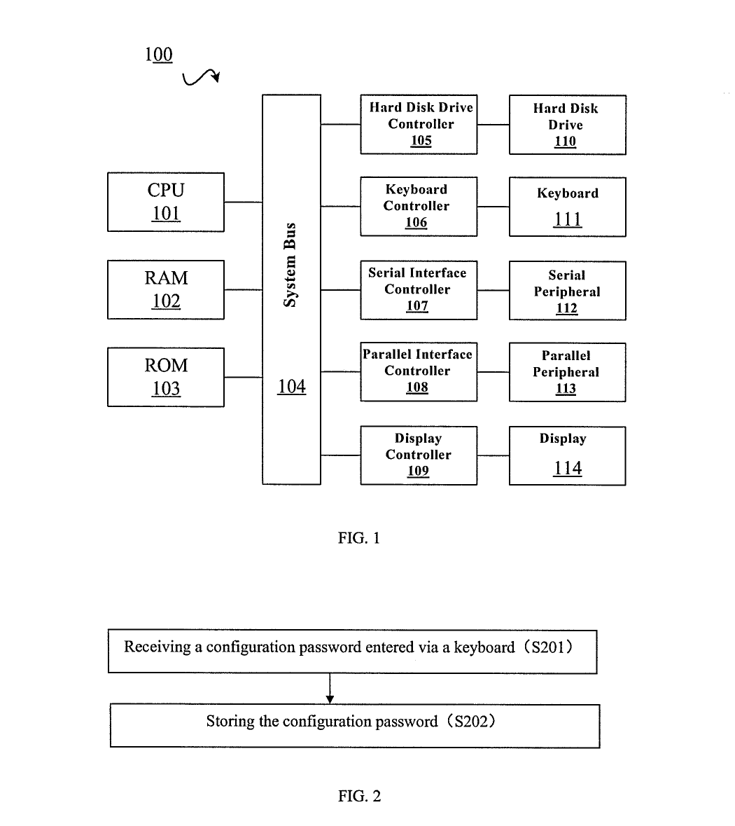

FIG. 1 illustrates an exemplary computer system 100 that is applicable to implement embodiments of the present invention. As shown in FIG. 1, the computer system 100 may include a central processing unit (“CPU”) 101, a random access memory (“RAM”) 102, a read only memory (“ROM”) 103, a system bus 104, a hard disk drive controller 105, a keyboard controller 106, a serial interface controller 107, a parallel interface controller 108, a display controller 109, a hard disk drive 110, a keyboard (or keypad) 111, serial peripheral equipment 112, parallel peripheral equipment 113, and a display 114. The CPU 101, RAM 102, ROM 103, hard disk drive controller 105, keyboard controller 106, serial interface controller 107, parallel interface controller 108, and display controller 109 are coupled to the system bus 104. The hard disk drive 110 is coupled to the hard disk drive controller 105. The keyboard 111 is coupled to the keyboard controller 106. The serial peripheral equipment 112 is coupled to the serial interface controller 107. The parallel peripheral equipment 113 is coupled to the parallel interface controller 108. And the display 114 is coupled to the display controller 109. It should be understood that embodiments of the present invention are not limited to the structure as shown in FIG. 1. In some cases, certain devices or components may be added to or removed from the computer system 100 based on specific situations.

Embodiments of the present invention may be embodied as a system, method, and/or computer program product. Accordingly, embodiments of the present invention may take the form of an entirely hardware embodiment, an entirely software embodiment (including firmware, resident software, micro-code, etc.), or an embodiment combining software and hardware aspects that may all generally be referred to herein as a “means,” “circuit,” “circuitry,” “module,” and/or “system.”

Furthermore, embodiments of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk (e.g., hard disk drive 110), a random access memory (e.g., RAM 102), a read-only memory (e.g., ROM 103), an erasable programmable read-only memory (“EPROM” or flash memory), an optical fiber, a portable compact disc read-only memory (“CD-ROM”), an optical storage device, a magnetic storage device (e.g., hard disk drive 110), or any suitable combination of the foregoing. In the context of this document, a computer readable storage medium may be any tangible medium that can contain, or store, a program for use by or in connection with an instruction execution system, apparatus, circuitry, and/or device.

A computer readable signal medium may include a propagated data signal with computer readable program code embodied therein, for example, in baseband or as part of a carrier wave. Such a propagated data signal may take any of a variety of forms, including, but not limited to, electromagnetic, optical, or any suitable combination thereof. A computer readable signal medium may be any computer readable medium that is not a computer readable storage medium and that can communicate, propagate, and/or transport a program for use by or in connection with an instruction execution system, apparatus, circuitry, or device.

Program code embodied on a computer readable medium may be transmitted using any appropriate medium, including but not limited to, wireless, wire line, optical fiber cable, RF, etc., or any suitable combination of the foregoing.

Computer program code for carrying out operations for embodiments of the present invention may be written in any combination of one or more programming languages, including an object oriented programming language, such as Java, Smalltalk, C++, or the like, and conventional procedural programming languages, such as the “C” programming language or similar programming languages. The program code may execute entirely on a user's computer (e.g., computer system 100), partly on a user's computer, as a stand-alone software package, partly on a user's computer and partly on a remote computer or server, or entirely on a remote computer or server. In the latter scenario, the remote computer (e.g., computer system 100) may be connected to a user's computer (e.g., computer system 100) through any type of network, including a local area network (“LAN”) and/or a wide area network (“WAN”), or a connection may be made to an external computer (e.g., computer system 100) (for example, through the Internet using an Internet Service Provider).

Embodiments of the present invention are described below with reference to flowchart illustrations (also referred to herein as flow diagrams) and/or block diagrams of methods, apparatus (systems), and computer program products. It will be understood that each block of a flowchart illustration and/or block diagram, and/or combinations of blocks in the flowchart illustrations and/or block diagrams, may be implemented by computer program instructions. These computer program instructions may be provided to a processor (e.g., CPU 101) of a general purpose computer, special purpose computer, or other programmable data processing apparatus to produce a machine (e.g., computer system 100), such that the instructions, which execute via the processor of the computer or other programmable data processing apparatus, create means and/or circuitry for implementing the functions/acts specified in a block and/or blocks in the flowchart illustrations and/or block diagrams.

These computer program instructions may also be stored in a computer readable medium that can direct a computer, other programmable data processing apparatus, or other devices to function in a particular manner, such that the instructions stored in the computer readable medium produce an article of manufacture including instructions that implement the functions/acts specified in a block and/or blocks in the flowchart illustrations and/or block diagrams.

The computer program instructions may also be loaded onto a computer (e.g., computer system 100), other programmable data processing apparatus, or other devices to cause a series of operational steps to be performed on the computer, other programmable data processing apparatus, or other devices to produce a computer implemented process such that the instructions, which execute on the computer, other programmable data processing apparatus, or other devices, provide processes for implementing the functions/acts specified in a block and/or blocks in the flowchart illustrations and/or block diagrams.

A keyboard or keypad as disclosed herein may be implemented as a hardware keyboard (e.g., keyboard 111), or a software keyboard (also referred to herein as a “soft keyboard”) displayed on a device (e.g., display 114). The layout of a hardware keyboard may be fixed, i.e., each physical key corresponds to a fixed symbol (e.g., number, letter, punctuation character, etc.), such as a hardware keyboard for a desktop or personal computer (“PC”), hardware keyboard on a cell phone, as well as a numeric keypad (e.g., on an ATM machine of a commercial bank). This kind of hardware keyboard is referred to as a fixed layout keyboard. There is also another kind of hardware keyboard, wherein each physical key does not always display the same fixed symbol information. In other words, the driving circuitry (e.g., keyboard controller 106), which may be controlled by the CPU (e.g., CPU 101), dynamically determines the symbol information displayed on each of the keys at any particular instant of time. Because the symbol information corresponding to each key is not permanently fixed, but instead is changeable and can be possibly random, this kind of keyboard is referred to as a randomly arranged keyboard (though the arrangements of the key symbols may be based on any type of algorithm and not necessarily a random number based algorithm). A “soft keyboard” may be displayed on a display as either a fixed layout keyboard or a randomly arranged keyboard, as controlled by the CPU and/or other circuitry controlling the keyboard display. Each key on the keyboard has associated with it symbol information and also its position information. In embodiments of the present invention, for setting and/or verifying a password, the symbol information associated with a key (e.g., the corresponding number, letter, or character information) is utilized in addition to the position information of the key on the keyboard (i.e., the physical location of the key on the keyboard (e.g., relative to the other keys)).

FIG. 2 illustrates a flow diagram of a process for setting a password for accessing a device or a device feature. Hereinafter, such a set password is referred to as a configuration password. In step S201, a configuration password entered via a keyboard is received (also referred to herein as captured), wherein the configuration password comprises position information of at least one key on the keyboard, and symbol information of at least one key on the keyboard. In step S202, the configuration password is stored, such as in a memory device in the computer system 100. The configuration password will now be the password needed for entry in the future for a user to access the device or device feature.

In the following, embodiments are described with respect to a numeric keyboard or keypad. Those skilled in the art will understand that the embodiments are not limited to application with a numeric keypad, but may apply to any computer keyboard, numeric keyboard or keypad, ATM keyboard or keypad, projection keyboard, and so on. As previously noted, a configuration password comprises position information of at least one key on the keyboard, and symbol information of at least one key on the keyboard, with several variations on how to enter the key position information. In some embodiments, the keyboard may have a specified (i.e., specialized or customized) key for entering position information for a key. For example, FIG. 3 illustrates a representation of a numeric keyboard with a key specifically labeled as “POS,” also referred to herein as the “POS” key. On the keyboard, the “POS” key is selected (e.g., physically pressed) by a user, and then a number key (e.g., any one of the 0-9 numbers) is selected, for capturing the position of the number key relative to the positions of the other keys on the keyboard. Alternatively, the “POS” key may be selected after a number key, etc. to accomplish this task. For example, a configuration password may be entered as either “1” “2” “3” “POS” “4” or “1” “2” “3” “4” “POS.” As such, every number on the keyboard represents a number (i.e., a symbol or value (“V”)) or an address of a key (i.e., a position (“P”)) depending on whether or not selection of that numbered key is performed in association with a selection of a position key(s), such as the “POS” key. For example, if the “POS” key is selected in association with selection of a number key (e.g., before or after selection of the “POS” key), then the address or position, of that number key is captured as a digit of the entered password; otherwise, it means the value, or symbol, of that number key is captured. Thus, the key position information may be obtained by prior agreement with the user, i.e., the user has been previously informed how the positions of the keys on the keyboard are to be determined. For example, the user has been previously made aware that the positions of the keys on the keyboard are numbered as on a standard fixed layout keyboard such as shown in FIG. 3.

For example, referring to FIG. 3, a user may select the five keys “1” “2” “3” “POS” and “4” respectively, which may be captured by the system as 1(V), 2(V), 3(V), 4(P), where the “V” label indicates the captured number represents the symbol information of a key on the keyboard, and the “P” label indicates the captured number represents the position of a key on the keyboard. As a result, the password then required to be entered in the future to access the device (required password for verification) is selection of the keys labeled with the “1” “2” “3” symbols, and selection of the key located in the “4” position on the keyboard regardless of its displayed symbol or value.

In another example, for a soft keyboard, the keyboard for setting a password will be displayed, and then the password to be set will be received on the soft keyboard. Using the above example, the “1” “2” “3” “4” keys may be input first (selected by the user), and then an interface is provided (e.g., displayed to the user) to indicate which of the key selections represent position information of a particular key and which represent symbol information of a particular key in the configuration password. For example, the first question in the interface may be “Did the configuration password use the position information of keys?” If the answer to the first question is yes, then the second question may be “How many keys position information have been use?” If the answer to the second question is “1,” the third question, and possibly later questions, may be “Input the position information of a key or keys.” For the above example, where the “4” key is to be captured as position information, the answer to the third question should be “4.” This implementation corresponds to selecting four keys “1,” “2,” “3,” “4” during setting of the password, wherein the selection of the “4” key uses position information, and the selections of other keys use symbol information.

Alternatively, a selection of a combination of keys may be used as a corollary to selection of the above “POS” key to set the password. Then, using the above example, the tour keys “1” “2” “3” “4” are still selected to set the password, wherein the “4” key is used as position information by the user entering on the keyboard a combination of keys (e.g., “9” “9” “9”) before or after selection of the “4” key. In this scenario, a user may be notified to avoid using that key combination (e.g., the “999” combination) when later entering the password to access the device.

Those skilled in the art can understand that other information may be used to set the password besides the position and symbol information of the keys on the keyboard.

In some embodiments, neither the “POS” key, nor any other interface to indicate a key's position, will be used to verify the password in the future; each key in the entered password will be verified using the configuration password stored (the verified implementation will be described later). Thus, the configuration password comprises the position information of at least one key on the keyboard, and symbol information of at least one key on the keyboard.

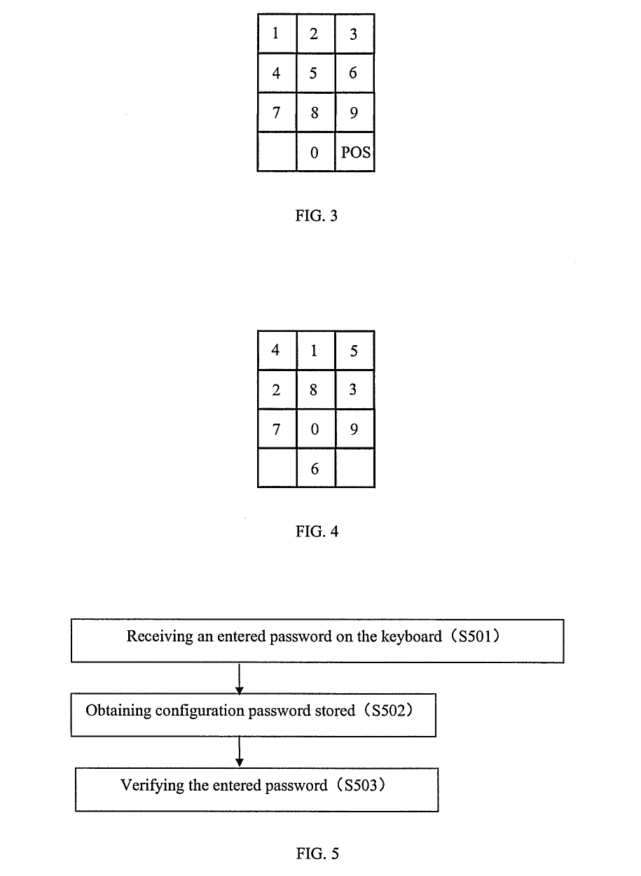

In embodiments, the stored configuration password comprises a label for indicating whether a code bit in the configuration password represents a corresponding position information of a key or the symbol information of a key. For example, the digital number “0” may be utilized to indicate the number key value (“V”), and the digital number “1” may be utilized to indicate the number key position (“P”). In the above example, the password may then be stored in memory as “10203041.” Thus, the stored “0” bits indicate the “1” “2” and “3” values mean keys displaying those numbers need to be selected as part of the password for verification; the “1” bit is stored to mean the “4” value indicates that the key on the keyboard at the “4” position (e.g., based on the standard keyboard positions shown in FIG. 3, the key labeled with the “2” on the keyboard shown in FIG. 4, is located at the “4” key position) needs to then be selected as part of the password for a correct verification. In other embodiments, the position information of a key in the configuration password is represented by symbol information of the key on a fixed layout keyboard. Of course, those skilled in the art can understand that the digital “0” and “1” are used here illustratively as an example; any other label may also be used. Or the label is not used, but an array is used instead. Alternatively, a database, a link list, or other format may be used. Furthermore, each key's position may be defined directly; for example, the coordinate of a fixed point of a key may be used to represent the key's position, such as the coordinates of the point on the upper right corner of the key, coordinates of the point on the lower left corner of the key, coordinates of the point on the lower right corner of the key, or coordinates of the center of the key, as the position of the key, respectively.

The configuration password may be either stored in a database or directly stored into a storage device. The above keyboard may he either a hardware keyboard, or a soft keyboard; and it may be either a fixed layout keyboard, or a randomly arranged keyboard.

FIG. 4 is now being referred to as illustrating a representation of an example of a randomly arranged keyboard that may be used by a user when setting a new password to be used later by the user for verification. Assuming that the “POS” key becomes located in the lower right corner of the keyboard as in FIG. 3 (the “POS” key is not shown in FIG. 4), first, a method operated by the CPU instructs a display device to display a randomly arranged keyboard for setting a password. Thus, a method operated by the CPU has preselected the positions of symbol information on the keyboard, and it then numbers the position information. For example, if the “POS” key (not shown) has been selected by a user, then the “5” key is selected, a method operated by the CPU will capture that the position information for the configuration password being set by the user on the keyboard is key “3.” Or, taking the previous example, if keys “1” “2” “3” “POS” “2” have been selected by a user, the password set by the user may be stored as “10203041” for example according to the above disclosed implementation in which the digit “0” stored after an entered key indicates that the value or symbol of that key is stored (in this example, the “1” “2” and “3” values), and the digit “1” stored after an entered key indicates that the position of that key is stored (in this example, the “4” position, since the key labeled with the “2” symbol is located at the “4” key position on the keyboard shown in FIG. 4).

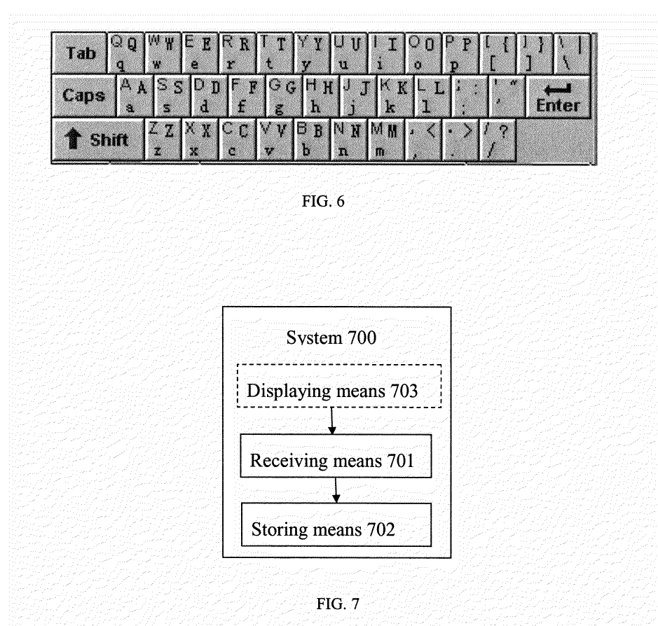

FIG. 5 illustratively shows a flow of a method for verifying a password entered by a user according to embodiments of the present invention. Such a verification password is being entered by the user at a later time for accessing the device or device feature now protected by the previously entered configuration password. At step S501, a password is received and captured as it is entered on a keyboard. The keyboard may be the same as the keyboard previously used to enter the configuration password or not. However, the keyboard may be displayed as a randomly arranged keyboard, because if other nearby people had seen the configuration password entered on a fixed layout keyboard, and the fixed layout keyboard is then also used to enter the password to be verified, such other nearby people will then be able to determine the password for accessing the device or device feature, e.g., the position information in the configuration password does not prevent others from determining the password. Taking the above example where the configuration password was previously set as “1” “2” “3” “POS” “4”, if a randomly arranged keyboard for verifying the password is as shown in FIG. 4, then the valid password that needs to be entered for a covert verification will be by selection of the “1” “2” “3” “2” keys because the “2” key is now located (e.g., displayed) at the “4” key position on the keyboard. In embodiments, if the randomly arranged keyboard is a soft keyboard, the method may further comprise displaying the keyboard on a display for verifying the password.

At step S502, a stored configuration password is obtained from where it was stored in the system 100, wherein the configuration password comprises the position information of at least one key on the keyboard, and symbol information of at least one key on the keyboard. In embodiments, the stored configuration password comprises a label for indicating whether a code bit in the configuration password stands for position information of a key or symbol information of a key. Taking the previously disclosed example of setting the password in which the stored configuration password is “10203041”, it can be determined that the first three keys represent the symbol information of keys, and the fourth key represents the position information of a key. Alternatively, the labels may be replaced by an array, replaced by a database, or linked lists. In embodiments, for the stored configuration password, the position information of the key on the keyboard in the configuration password is represented by the symbol information of the key(s) on the fixed layout keyboard when it was entered. Of course, as described above, other embodiments may also be used.

At step S503, a password entered by a user is verified based on the stored configuration password (e.g., the entered password is compared to the stored configuration password). In embodiments, the method comprises obtaining which is the position information of a key and which is the symbol information of a key in the configuration password; and determining whether the position information of a key and the symbol information of a key in the configuration password are the same as those in the password entered by the user. For example, if a code bit in the configuration password indicates that its associated entered key is the position information of the key (e.g., stored code hit is “1”), then the key in the entered password is determined whether it is the same position of the key; if a code hit in the configuration password indicates that its associated entered key is the symbol information of the key (e.g., stored code bit is “0”), then the key in the entered password is determined whether it is the same symbol information of the key. Again, using the previous example where the stored configuration password is “10203041”, the user would need to enter (select) the “1” “2” “3” and “2” keys on the keyboard displayed in FIG. 4 for these to be a properly verified password to access the device or device feature.

In embodiments, the method comprises obtaining which is the position information of a key and which is the symbol information of a key in the configuration password; modifying the entered password to same format as the configuration password based on the position information of a key and the symbol information of a key in the configuration password; and determining whether the entered password with the same format as the configuration password are the same as the configuration password. It will be clear for those skilled in the art that the method may further comprise in response to a successful verification, the entered password is accepted; and in response to a failed verification, the entered password is rejected.

The foregoing embodiments for setting and verifying a password make it difficult for a person near the user to determine the password. Taking the previous example, the person near the user may see that the password inputted by the user is selection of the “1” “2” “3” “2” keys on the randomly arranged keyboard shown in FIG. 4, and will thus believe that these values of digits (i.e., symbols) comprise the password. But when the randomly arranged keyboard is displayed on the screen for receiving the inputted password from the user for verification, the possibility of “2” key being displayed at the position of the “4” key on a standard keyboard (e.g., such as the keyboard illustrated in FIG. 3) is less than 10%. Thus, the next time the randomly arranged keyboard is displayed for entering of the password to access the device or device feature, it is likely that the “2” symbol will be displayed at a different key position on the keyboard. But, selection of that key will not be verified as a valid password since the valid password requires selection of the key at the “4” position. The more keys that have been set to use for position information in the password, the less the possibility for the nearby person to determine the password. Therefore, in such embodiments, the password can be effectively protected from snooping.

Numeric keypads are used for the keyboards in the above examples. FIG. 6 schematically illustrates an example of a computer's standard keyboard, where each key has associated with it symbol information and position information (e.g., in system 100). The symbol information and the position information and their correspondent relationship with each other may also be randomly arranged. The above method may be implemented in a randomly arranged hardware or software keyboard. Further, a specific key (e.g., the “Z” key) may be selected to be defined and function as the position key, similar to the functionality of the “POS” key.

Embodiments of the present invention provide a system for setting a password (e.g., using process described with respect to FIG. 2). FIG. 7 illustrates a simplified block diagram of a system 700 for setting a password according to embodiments of the present invention. System 700 may be implemented within a system similarly configured as system 100. System 700 comprises a receiving means and/or circuitry 701 configured and/or suitable to receive and/or capture a configuration password entered via a keyboard, wherein the configuration password comprises position information of at least one key on the keyboard, and symbol information of at least one key on the keyboard; and a storing means and/or circuitry 702 configured and/or suitable to store the received and/or captured configuration password. In embodiments, the keyboard may be a randomly arranged keyboard. In other embodiments, the keyboard may be a fixed layout keyboard. In embodiments, the keyboard may comprise a specified key for entering position formation of a key.

In embodiments, the stored configuration password comprises a label for indicating whether a code bit (e.g., a “0” or “1” bit) in the configuration password stands for position information of a key (e.g., P) or symbol information of a key (e.g., V). In embodiments, the position information of a key in the configuration password may be represented by symbol information of the key on a standard fixed layout keyboard (such as shown in FIG. 3). In embodiments, the system may further comprise a displaying means and/or circuitry 703 configured and/or suitable to display the keyboard for receiving and/or capturing the entered password.

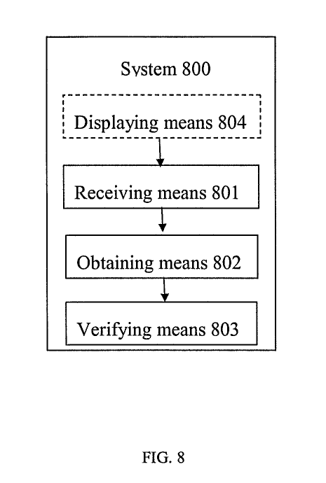

Embodiments of the present invention provide a system for verifying a password entered into a system (e.g., using process described with respect to FIG. 5). FIG. 8 illustrates a simplified block diagram of a system 800 for verifying a password according to embodiments of the present invention. System 800 may be implemented within a system similarly configured as system 100. System 800 comprises a receiving means and/or circuitry 801 configured and/or suitable to receive and/or capture a password entered on a keyboard; and an obtaining means and/or circuitry 802 configured and/or suitable to obtain or retrieve a stored configuration password, wherein the configuration password comprises position information of at least one key on the keyboard, and symbol information of at least one key on the keyboard; and a verifying means and/or circuitry 803 configured and/or suitable to verify the entered password based on the configuration password. The keyboard may be a randomly arranged keyboard. The system 800 may further comprise a displaying means and/or circuitry 804 configured and/or suitable to display the keyboard used for entering the password to be verified.

In embodiments, the verifying means and/or circuitry 803 is further configured and/or suitable to obtain that which is the position information of a key and that which is the symbol information of a key in the configuration password, and determine whether the position information of a key and the symbol information of a key in the configuration password are the same as those in the entered password to be verified.

In embodiments, the verifying means and/or circuitry 803 is further configured and/or suitable to obtain that which is the position information of a key and that which is the symbol information of a key in the configuration password, modify the entered password to a same format as the configuration password based on the position information of a key and the symbol information of a key in the configuration password, and determine whether the entered password modified with the same format as the configuration password is the same as the configuration password.

In embodiments, the configuration password comprises a label for indicating whether a code bit (e.g., a “0” or “1” bit) in the configuration password stands for the position information of a key (e.g., “P”) or the symbol information of a key (e.g., “V”). In embodiments, the position information of a key in the configuration password is represented by the symbol information of the key as selected on a standard fixed layout keyboard.

The flowcharts and block diagrams in the figures illustrate the architecture, functionality, and operation of possible implementations of systems, methods, and/or computer program products according to various embodiments of the present invention. In this regard, one or more blocks in a flowchart or block diagram may represent a module, segment, and/or portion of code, which comprises one or more executable instructions for implementing the specified logical function(s). It should also be noted that, in some implementations, the functions may occur out of the order noted in the figures. For example, two blocks shown in succession may be executed substantially concurrently, or the blocks may sometimes be executed in a reverse order, depending upon the functionality involved. It should also be noted that one or more blocks of a block diagram and/or a flowchart illustration, and/or combinations of blocks in a block diagram and/or flowchart illustration, may be implemented by special purpose hardware-based systems that perform the specified functions or acts, and/or combinations of special purpose hardware and computer instructions.

The descriptions of the various embodiments of the present invention have been presented for purposes of illustration, but are not intended to be exhaustive or limited to the embodiments disclosed. Modifications and variations will be apparent to those of ordinary skill in the art without departing from the scope and spirit of the described embodiments. The terminology used herein was chosen to explain principles of the embodiment(s), the practical application(s), and/or technical improvement(s) over technologies found in the marketplace, and/or to enable others of ordinary skill in the art to understand the embodiments disclosed herein. As used herein, a plurality of items, structural elements, compositional elements, and/or materials may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary.

The terms “a” and “an” mean “one or more” when used in this application, including the claims. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. The term “comprising,” which is synonymous with “including,” “containing,” or “characterized by,” is inclusive or open-ended and does not exclude additional, unrecited elements or method steps. “Comprising” is a term of art used in claim language which means that the named elements are present, but other elements can be added and still form a construct or method within the scope of the claim.

What is claimed is:

1. A method for setting a password, comprising:
receiving a configuration password entered via a keyboard, wherein he configuration password comprises position information of at least one key selection on the keyboard, and wherein the configuration password comprises symbol information of at least one key selection on the keyboard; and
storing the configuration password in an electronic memory.

2. The method as recited in claim 1, wherein the keyboard is a randomly arranged keyboard wherein an arrangement of symbols on keys of the randomly arranged keyboard are dynamically re-arranged during successive utilizations of the randomly arranged keyboard.

3. The method as recited in claim 1, wherein the position information of a key in the configuration password is a function of symbol information pertaining to the key as selected on a standard fixed layout keyboard.

4. The method as recited in claim 1, wherein the keyboard comprises a specialized key for entering position information of a key.

5. A method for verifying a password, comprising:
receiving a password entered on a randomly arranged keyboard;
obtaining a previously stored configuration password, wherein the configuration password comprises position information of at least one key on the randomly arranged keyboard, and symbol information of at least one key on the randomly arranged keyboard; and
verifying the entered password based on the configuration password.

6. The method as recited in claim 5, wherein the verifying the entered password based on the configuration password further comprises:
determining from the configuration password that which is the position information of a key and that which is the symbol information of a key; and
determining whether the position information of a key and symbol information of a key in the configuration password are same with those in the password entered on the randomly arranged keyboard.

7. The method as recited in claim 5, further comprising granting access to a device or a device feature in response to the entered password being verified.

8. The method as recited in claim 5, wherein the position information of a key in the configuration password is a function of symbol information pertaining to the key as selected on a standard fixed layout keyboard.

9. A system comprising:
receiving circuitry suitable for receiving a configuration password entered via a keyboard, wherein the configuration password comprises position information of at least one key on the keyboard, and symbol information of at least one key on the keyboard; and
storing circuitry suitable for storing the configuration password.

10. The system as recited in claim 9, wherein the keyboard is a randomly arranged keyboard.

11. The system as recited in claim 10, wherein the position information of a key in the configuration password is a function of symbol information pertaining to the key as selected on a standard fixed layout keyboard.

12. The system as recited in claim 9, wherein the keyboard is a fixed layout keyboard.

13. The system as recited in claim 9, wherein the keyboard comprises a customized key for entering the position information.

14. The system as recited in claim 9, further comprising a display suitable for displaying the keyboard for entering the password.

15. A system comprising:
receiving circuitry suitable for capturing a password entered on a randomly arranged keyboard;
obtaining circuitry suitable for retrieving a previously stored configuration password, wherein the configuration password comprise position information of at least one key on the randomly arranged keyboard, and symbol information of at least one key on the randomly arranged keyboard; and
verifying circuitry suitable for verifying the entered password based on the configuration password.

16. The system as recited in claim 15, wherein the configuration password comprises code bits in the configuration password that stand for the position information of a key and the symbol information of a key.

17. The system as recited in claim 15, wherein the verifying circuitry further comprises:
circuitry for obtaining in the configuration password that which is the position information of a key and which is the symbol information of a key; and
circuitry for determining whether the position information of a key and symbol information of a key in the configuration password are same with those in the entered password.

18. The system as recited in claim 15, wherein the position information of a key in the configuration password is a function of symbol information pertaining to the key as selected on a standard fixed layout keyboard.

19. The system as recited in claim 15, further comprising a display suitable for displaying the randomly arranged keyboard for entering the password.

20. The system as recited in claim 15, further comprising:
receiving circuitry suitable for receiving the configuration password entered via a keyboard; and
storing circuitry suitable for storing the configuration password.

21. A computer program product comprising a computer readable storage medium having computer readable program code embodied therewith, the computer readable program code comprising:
computer readable program code configured to receive a configuration password entered via a first set of key selections on a first keyboard, wherein the configuration password comprises position information of at least one of the key selections on the first keyboard, and wherein the configuration password comprises symbol information of at least one of the key selections on the first keyboard; and
computer readable program code configured to store the configuration password.

22. The computer program product as recited in claim 21, further comprising:
computer readable program code configured to receive a verification password entered via a second set of key selections on a second keyboard;
computer readable program code configured to verify the entered verification password based on the configuration password; and
computer readable program code configured to permit access to a device or device feature when the entered verification password matches the configuration password.

23. The computer program product as recited in claim 21, wherein the second keyboard is a randomly arranged keyboard.

24. The computer program product as recited in claim 22, wherein the first keyboard is a standard fixed layout keyboard.

25. The computer program product as recited in claim 23, wherein an arrangement of symbols on the randomly arranged keyboard is different than an arrangement of the symbols on the standard fixed layout keyboard.
